(19) United States
(12) Patent Application Publication
(10) Pub. No.: US 2025/0097005 A1
(43) Pub. Date: Mar. 20, 2025

(54) CRYPTANALYSIS ANALYTICAL MONITORING AND OBSERVATION (CAMO)

(71) Applicant: Wells Fargo Bank, N.A., San Francisco, CA (US)

(72) Inventors: Jeffrey J. Stapleton, O'Fallon, MO (US); Peter Bordow, Fountain Hills, AZ (US); Dale C. Miller, San Francisco, CA (US)

(73) Assignee: Wells Fargo Bank, N.A., San Francisco, CA (US)

(21) Appl. No.: 18/369,077

(22) Filed: Sep. 15, 2023

(51) Int. Cl. H04L 9/00; H04L 9/08; H04L 9/14; H04L 9/30

(52) U.S. Cl. CPC H04L 9/002; H04L 9/0861; H04L 9/14; H04L 9/3073

(57) ABSTRACT

The arrangements disclosed herein relate to systems, apparatus, methods, and non-transitory computer readable media for determining, based on at least one cryptographic attribute, that information on a site is a first cryptographic key, and sending an alert that at least one of the first cryptographic key or a second cryptographic key corresponding to the first cryptographic key is compromised.

### BACKGROUND

Attackers who illegally obtain sensitive user information may share or offer for sale such information on certain platforms, including the Dark Web or the Darknet. The Darknet includes networks that can be accessed using specialized applications including software and protocol. It can be challenging to monitor the Dark Web to identify stolen sensitive user information.

### SUMMARY

The arrangements disclosed herein relate to systems, apparatuses, non-transitory computer-readable media, and methods for determining, based on at least one cryptographic attribute, that information on a site is a first cryptographic key and sending an alert that at least one of the first cryptographic key or a second cryptographic key corresponding to the first cryptographic key is compromised.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic block diagrams illustrating an example system for implementing Cryptanalysis Analytical Monitoring and Observation (CAMO), according to various arrangements.

FIG. 2 is a block diagram of an example of the CAMO device of the system set forth in FIG. 1, according to some arrangements.

FIG. 3 is a flowchart diagram illustrating an example CAMO method, according to various arrangements.

### DETAILED DESCRIPTION

This arrangements disclosed herein relate to systems, apparatuses, methods, and non-transitory computer-readable media for CAMO implemented to discover an instance of cryptographic material such as asymmetric private keys in the “wild” (e.g., the Dark Web) which is intended to be protected from disclosure or compromise for example, given that the cryptographic materials was contained within the cryptographic boundary of a Hardware Security Module (HSM). The occurrence of the cryptographic materials being in the “wild” implies that other cryptographic materials such as the public keys corresponding to the private keys have been broken to derive the private keys. Symmetric keys can also be discovered in the “wild” with other cryptographic materials.

Most dark web monitoring systems seek illicit repository of stolen information (e.g., passwords, Social Security Numbers (SSNs), Personally Identifiable Information (PII), Protected Health Information (PHI), Primary Account Number (PAN) or Personal Identification Number (PIN), and so on) based on the assumption that the legitimate repository storing such information has been breached. Poorly managed cryptographic keys may be compromised but properly key management methods, including security protocols (e.g., Transport Layer Security (TLS), Security Shell (SSH), Internet Protocol Security (IPsec), Key Management Interoperability Protocol (KMIP), and so on) and using HMS may prevent disclosure of cryptographic material.

Consequently, the discovery of a private key instance implies the public key has been broken following a cryptanalytical attack using a classical computer or a quantum computer. Moore's Law has and will continue to apply to cryptographic process in transitioning toward stronger cryptographic algorithms and greater-length keys. However, inevitable quantum computing (e.g., Shor's Algorithm) will break legacy asymmetric cryptography (e.g., Rivest-Shamir-Adleman (RSA), Diffie-Hellman, Elliptic-Curve Cryptography (ECC), and so on).

In some arrangements, an asymmetric key is generated as public/private key pair using explicit mathematical equations with predetermined domain parameters, e.g., in Diffie-Hellman (DH) cryptographic algorithm and elliptic curve DH. In other arrangements the public/private key pair is generated using random prime numbers, e.g., in RSA. Consequently, the public key has recognizable mathematical structure. The corresponding private key has related mathematical structure that can be used for recognition and confirmation of the private key and public key relationship. Accordingly, instead of identifying a data breach in which cryptographic materials such as cryptographic keys may be compromised, the arrangements of the present disclosure identifies potential cryptographic keys that may be present or displayed on certain sites known for trafficking stolen cryptographic materials.

In response to determining that a corresponding public key is known or discoverable, the public key ownership information (e.g. X.509 certificates) can be used to determine the public key lifecycle and the potential compromise point. For example, the public key certificate is either self-signed by the public key owner, or signed by a private or public Certification Authority (CA). Either the public key owner or the CA provides information about the key pair. The pedigree of the asymmetric key pair can provide information about the attacker or the targets. In some arrangements, a symmetric key is encrypted within a structure referred to as a key block (e.g., key wrapping) which may contain ownership information that identifies a key owner of the symmetric key. Thus, in response to discovering a cleartext symmetric as described herein, the system can determine an owner based on the ownership information contained in the key block.

In scenarios relating to cryptographic keys, the attacker with cryptanalysis capabilities who steals the key is not necessarily the benefactor. Rather, much like stolen credentials and data today, the attacker sells the compromised key to a third party. However, an attacker with access to quantum computers, possibly a nation state, may not wish to reveal its “Q-day” capability. An attacker using non-quantum cryptanalysis or after when Q-day has passed may sell the keys. Alternatively, even if the attacker uses the private keys themselves, the first attacker's site may be breached such that the private keys are reposted by a second attacker. In this scenario, the private keys may still be discoverable.

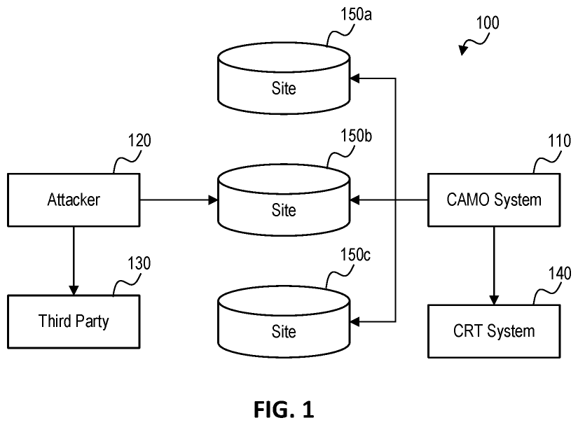

FIG. 1 is a schematic block diagrams illustrating an example system 100 in which CAMO can be implemented to identify and alert stolen cryptographic materials, according to various arrangements. An attacker 120 refers to a malicious actor and a computing system operated by the malicious actor. The attacker 120 has computing and processing capabilities to break or crack a public key of an entity (e.g., an owner of the public key) in a cryptanalytical attack. In that regard, the attacker 120 can include a classical computing system or a quantum computing system having suitable processing capabilities. Due to the processing power of a quantum computing system, the attacker 120 may be able to break the public key using a brute force attack. The attacker 120 can determine a private key from the corresponding public key. For example, the attacker 120 can derive the private key using the public key and its associated domain parameters.

In some examples, each of the sites 150a, 150b, and 150c can include one or more of a database, information repository, site, platform, application, and so on. The information in sites 150a, 150b, and 150c, including the private key, may be viewed by any party with access and authentication to the site 150b. The attacker 120 can post the private key on the site 150b. The attacker 120 intends to sell the private key to a third party 130. The third party 130 refers to a third party user and a computing system operated by that third party user. The third party user is different from the attacker 120 and the owner of the private key. The third party 130 intends to purchase the private key offered by the attacker 120 for sell. For example, the third party 130 may browse the site 150b for the private key and offers to purchase the private key by sending a request to the attacker 120 or initiating a transaction with the attacker 120 whereby compensation is offered to the attacker 120 in exchange for the private key. the attacker 120 itself may be breached by another attacker such that the private keys are reposted by that second attacker to the site 150b.

In some arrangements, a CAMO system 110 scans the sites 150a, 150b, and 150c for cryptographic materials. For example, the CAMO system 110 can identify the private key obtained by the attacker 120 in the site 150b. As discussed in further details herein, the CAMO system 110 can determine or otherwise recognize that certain information, which may appear to be random or non-sensical, is in fact a private key. In response, the CAMO system 110 can send an alert to the Cybersecurity Response Team (CRT) system 140. The CRT system 140 can begin investigating the incident.

The CRT response incident investigation can determine if the private key belongs to an entity (e.g., an enterprise, an organization, a system, a company, or a user) or determine the entity to which the private key belongs. The CRT system 140 can follow enterprise procedures including notifying internal groups of the entity, notifying a Law Enforcement Officer (LEO) of the breach, and notifying any additional entities as needed. In response to determining that the private key compromise further disclosed data, breach notification processes can be observed.

In some examples, the CAMO system 110 can access information stored on the sites 150a, 150b, and 150c via a first network. The first network may be the Darknet or the Dark Web, or another network that can be accessed using specialized software, configuration, authorization, encryption, routing, and so on. For example, the first network can be access via a specialized browser. In addition, the CAMO system 110 can be communicably coupled to the CRT system 140 via a second network. The second network can be a public or general network such as the World Wide Web.

Each of the first network and the second network can be supported by any suitable Local Area Network (LAN), Wide Area Network (WAN), or a combination thereof. For example, each of the first network and the second network can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. Each of the first network and the second network is structured to permit the exchange of data, values, instructions, messages, and the like.

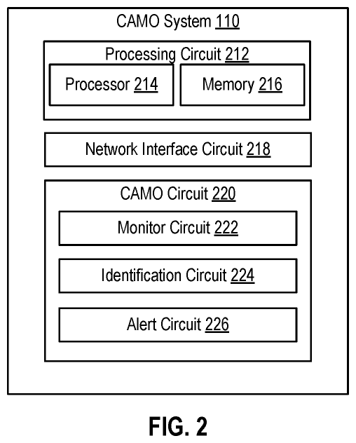

FIG. 2 is a block diagram of an example of the CAMO device 110 of the system 100 set forth in FIG. 1, according to some arrangements. Referring to FIGS. 1 and 2, the CAMO device 110 is shown to include various circuits and logic for implementing the operations described herein. More particularly, the CAMO device 110 includes one or more of a processing circuit 212, a network interface circuit 218, and a CAMO circuit 220. While various circuits, interfaces, and logic with particular functionality are shown, it should be understood that the CAMO device 110 includes any number of circuits, interfaces, and logic for facilitating the operations described herein. For example, the activities of multiple circuits are combined as a single circuit and implemented on a same processing circuit (e.g., the processing circuit 212), as additional circuits with additional functionality are included.

In some arrangements, the processing circuit 212 includes a processor 214 and a memory 216. The processor 214 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 216 (e.g., Random Access Memory (RAM), Read-Only Memory (ROM), Non-Volatile RAM (NVRAM), Flash Memory, hard disk storage, etc.) stores data and/or computer code for facilitating the various processes described herein. Moreover, the memory 216 is or includes tangible, non-transient volatile memory or non-volatile memory. Accordingly, the memory 216 includes database components, object code components, script components, or any other type of information structure for supporting the various activities and information structures described herein. The processing circuit 212 can be used to implemented one or more of the circuits 218 and 220.

The network interface circuit 218 is configured for and structured to establish a connection and communicate with the sites 150a, 150b, and 150c via the first network and communicate with the CRT system 140 using the second network. The network interface circuit 218 is structured for sending and receiving data over a communication network (e.g., the first and second networks). Accordingly, the network interface circuit 218 includes any of a cellular transceiver (for cellular standards), wireless network transceiver (for 802.11X, ZigBee, Bluetooth, Wi-Fi, or the like), wired network interface, or a combination thereof. For example, the network interface circuit 218 may include wireless or wired network modems, ports, baseband processors, and associated software and firmware.

The CAMO circuit 222 can perform functions and operations described herein relating to CAMO. The CAMO circuit 222 includes a monitoring circuit 222, an identification circuit 224, and an alert circuit 226. The monitoring circuit 222 is configured to monitor the sites 150a, 150b, and 150c for potential cryptographic materials. For example, the monitoring circuit 222 can include or implement a web crawler that crawls the pages, posts, and so on of the sites 150a, 150b, and 150c to extract and analyze information thereon to identify cryptographic materials. The monitoring circuit 222 can determine that information (e.g., a string) on the sites 150a, 150b, and 150c is a potential cryptographic material (e.g., an asymmetric private cryptographic key, a symmetric private key, and so on). The identification circuit 224 is configured to identify an entity to which the cryptographic material belongs. The alert circuit 226 is configured to send an alert of cryptographic material compromise to at least one entity that may own the cryptographic material or a third party entity.

In some examples, the monitoring circuit 222 can identify that certain information stored or displayed on the sites 150a, 150b, and 150c correspond to a cryptographic material (e.g., a cryptographic key) based on at least one cryptographic attribute. As used herein, a cryptographic attribute refers to an attribute of a cryptographic material that can be used to determine that certain unknown, previously unidentified information is a cryptographic material. For example, a cryptographic key can be generated using certain industry standards to assure the appropriate level of cryptographic strength. In addition, a cryptographic key can be generated using certain mathematical algorithms such as RSA, Diffie-Hellman, ECC, and so on. Therefore, by inspecting certain aspects of the information present on the sites 150a, 150b, and 150c, the CAMO circuit 222 can identify potential cryptographic materials that may have been compromised.

For example, a cryptographic attribute of a cryptographic key can include a length or a size of a string. That is, in response to determining that a string (e.g., which can be a random symmetric key) on a site has a certain predetermined length (e.g., 248 bits, 512 bits, 1024 bits, 2048 bits, and so on for an RSA key), the monitoring circuit 222 can determine that the string is a cryptographic key. In some examples, in response to determining that a string on a site has a length that is within a predetermined range of lengths, the monitoring circuit 222 can determine that the string is a cryptographic key. In some examples, the string posted on the site 150b may be a private key, which has the same size or length as the corresponding public key which the attacker 120 has broken. Further, in response to determining that a string (which can be an encryption key) is associated with a known parameter, such as a Check Key Value (KCV) or another identifier,), the monitoring circuit 222 can determine that the string is a cryptographic key.

In some arrangements, the entity that own a large number of encryption materials or a designated entity (e.g., an HSM) can create a specialized decoy string (e.g., a decoy public key) to be stored along with the rest of the cryptographic materials of the entity, e.g., in an HSM managing the cryptographic materials of the entity. A “honey pot” scheme can be implemented with such specialized decoy string. For example, a complementary or corresponding decoy string (e.g., a decoy private key or a predetermined string) can be determined using a suitable cryptographic algorithm such as RSA, Diffie-Hellman, ECC, and so on. That is, the entity or the HSM can generate a decoy private key that corresponds to the decoy public key. The monitoring circuit 222 can search for the decoy string (e.g., the decoy public key) and/or the complementary decoy string (e.g., the decoy private key) when monitoring the sites 150a, 150b, and 150c. Thus, the cryptographic attribute can include at least one of the of the decoy string or the complementary decoy string.

In some examples, the decoy string and the complementary decoy string, which may form a pair (e.g., a public/private key pair) can be outdated, invalid, expired, previously used, or insecure encryption materials that may have been previously generated and can no longer be used to meet the current security standards of the entity. In such case, the entity may retire such strings and use them as the decoy string and/or the complementary decoy string. This conserves time and computing resources given that the decoy string and the complementary decoy string do not need to be generated.

In some arrangements, the cryptographic materials that may be posted on the sites 150a, 150b, and 150c may have recognizable mathematical structure. For example, the public key and the corresponding private key that form a public/private key pair may have the same or related underlying mathematical structure. In some examples, each of a private key, a public key, or a symmetric key can be characterized as a string of random or pseudorandom characters. Thus, the randomness of the characters in a string posted on a site can be evaluated. In some examples, the monitoring circuit 222 can run a randomness test on the characters of a string (e.g., a statistical randomness test, entropy test, and so on). In response to determining a randomness score or entropy to exceed a predetermined threshold, the monitoring circuit 222 can determine that the string is a private key (or another cryptographic key that has random characteristics).

In some examples, given that cryptographic keys (e.g., symmetric keys) are relatively random or pseudorandom, in response to determining that the correlation between two strings on a same site, a same page, a same post, a same paragraph, a same tab, a same line, and so on is low, the monitoring circuit 222 can determine that the two strings are private keys (or other cryptographic keys). The monitoring circuit 222 can perform one or more of the Pearson correlation, Spearman correlation, Kendall rank correlation, and so on, on the characters in two strings to determine the correlation thereto.

In some examples, given that each cryptographic key is relatively random or pseudorandom, in response to determining that the frequency of each value or character in a string of the cryptographic key is similar or uniform, meaning that each value can occur in the string with almost equal probability, the monitoring circuit 222 can determine that the string is a private keys (or another cryptographic key that has random characteristics). The monitoring circuit 222 can perform one or more of histogram, bitcount, or chi-square test to determine the frequency of each value or character. The frequency values of a string can be considered similar or uniform in response to determining that the greatest difference between the frequency values of a string is within a range, is below a threshold, or in response to determining that the variance of frequency value among the frequency values of a string is within a range or below a threshold.

In some examples, in response to determining that an avalanche effect of a string posted on the site is within a predetermined range of an expected value (e.g., 50%), the monitoring circuit 222 can determine that the string is a private keys (or another cryptographic key that has random characteristics). The avalanche effect value of x % means that a change in one value or one bit in the string changes half of the values or bits in a ciphertext generated using a known cleartext and the string as a key. The monitoring circuit 222 can perform one or more of Hamming distance, Hamming weight, or so on to determine the avalanche effect of a string.

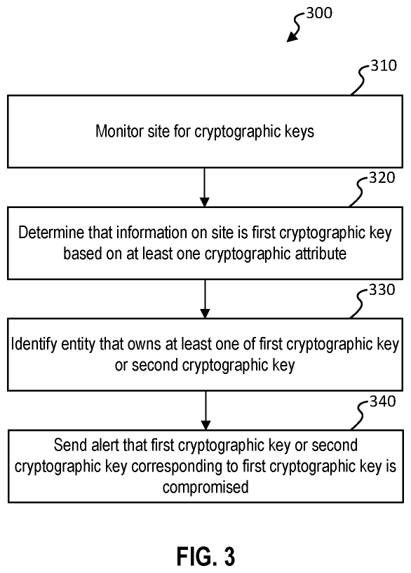

FIG. 3 is a flowchart diagram illustrating an example CAMO method 300, according to various arrangements. The method 300 can be performed by the CAMO system 110. At 310, the monitor circuit 222 can monitor at least one site (e.g., the sites 150a, 150b, and 150c) for cryptographic keys. For example, the monitor circuit 222 can employ a web crawler that crawls the sites 150a, 150b, and 150c for potential strings that can be a cryptographic material (e.g., a cryptographic key such as a private key). The monitor circuit 222 periodically check known addresses, links, posts, posters or users, pages, and so on that have posted cryptographic materials in the last. In some examples, monitoring the site for cryptographic materials (e.g., cryptographic keys) includes accessing the site (e.g., the cite 150b) via a first network (e.g., the Dark Web or the Dark Net) using a first browser (e.g., a browser configured to access the Dark Web or the Dark Net) configured to access the site.

At 320, the monitor circuit 222 can determine that information on a site (e.g., the cite 150b) is a first cryptographic key based on at least one cryptographic attribute. In some examples, the least one cryptographic attribute includes a length of a string on the site 150b. Determining, based on the at least one cryptographic attribute, that the information on the site is the first cryptographic key includes determining that the string has a length equal to a predetermined length or within a predetermined range of lengths. In some examples, the first cryptographic key can be a key used by the attacker 120 to encrypt another cryptographic key (e.g., a third cryptographic key). An encrypted version of the third cryptographic key can be posted on the sit 150b as string, similar to described relative to the first cryptographic key.

In some examples, the at least one cryptographic attribute includes a predetermined string such as a decoy private key, a decoy string, and so on. In some examples, the at least one cryptographic attribute comprises at least one of a randomness of the string, a correlation between the string and another string also posted on the site 150b, a frequency of a value in the string, an avalanche effect of a value in the string, and so on.

At 340, the identification circuit 224 can identify an entity that owns at least one of the first cryptographic key or the second cryptographic key. In some examples, the first cryptographic key comprises a private key. The second cryptographic key includes a public key corresponding to the private key. The private key and the public key are generated as a public/private key pair. In some arrangements, the first cryptographic key and the second cryptographic key are asymmetric keys. In other arrangements, the first cryptographic key and the second cryptographic key are symmetric keys (e.g., Advanced Encryption Standard (AES) keys), and the first cryptographic key and the second cryptographic key might be the same, or the second cryptographic key can be derived from the first cryptographic key using a key derivation function.

In some arrangements, the identification circuit 224 can determine the second cryptographic key that corresponds to the first cryptographic key. In the examples in which the first cryptographic key is a private key, the identification circuit 224 can generate a corresponding public key (e.g., the second cryptographic key) using a key generation algorithm consistent with the cryptographic attribute. For example, for the detected private key having a given length (e.g., 2048), the identification circuit 224 can determine that the private key is generated using the RSA algorithm based on the length, and derive the public key using the RSA algorithm or the mathematical relationship between the private key and the public key. For example, RSA has a function that allows a user to derive the public key from the private key. The identification circuit 224 can search a database included as part of the CAMO system 110, the CRT system 140, one or more Certificate Authorities (CAs), or another third-party database for a certificate of the public key. The certificate contains other information about the public key, such as the entity (e.g., an enterprise, an organization, a system, a company, or a user) that is the owner of the public key and the private key.

In some arrangements, the identification circuit 224 can determine, identify, or extract identifying information associated with the first cryptographic key that may be posted with the first cryptographic key on the site 150b. For example, the attacker 120 or the third party 130 can post certain information or identifier that identifies the entity to which the first cryptographic key and/or the second cryptographic key belongs, in order for any potential purchaser or user to evaluate the value of those keys. The identifying information (e.g., a string) may be displayed adjacent to the information (e.g., another string) corresponding to the first cryptographic key. For example, the identifying information can be displayed in a same post in the site 150b as the information corresponding to the first cryptographic key, on a same page of the site 150b as the information corresponding to the first cryptographic key, in a same line or paragraph as the information corresponding to the first cryptographic key, in a next line or previously line as the information corresponding to the first cryptographic key, and so on. The identification circuit 224 can query a database included as part of the CAMO system 110, the CRT system 140, or another third-party database for the identifying information, and if a match is found, the identification circuit 224 can determine the entity that matches the identifying information. In some examples, the extracting the identifying information includes determining the identifying information from a key block, wherein the first cryptographic key and the second cryptographic key are symmetric keys.

At 340, the alert circuit 226 sends an alert that at least one of the first cryptographic key or the second cryptographic key corresponding to the first cryptographic key is compromise. In some examples, the alert message is sent to the CRT system 140 via a second network using a second browser. The first browser and the second browser are different. The first network and the second network is different. For example, the second network is the World Wide Web or a private network between the CAMO system 110 and the CRT system 140. In some examples, the alert circuit 226 sends an alert message to the entity identified at 330, via the second network (e.g., the World Wide Web or a private network between the CAMO system 110 and the entity's enterprise computing system). In some examples, the alert circuit 226 sends an alert message to the managing server for the HSM or the CA managing a certificate for the public key corresponding to the detected private key.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method, comprising:
determining, based on at least one cryptographic attribute, that information on a site is a first cryptographic key; and
sending an alert that at least one of the first cryptographic key or a second cryptographic key corresponding to the first cryptographic key is compromised.

2. The method of claim 1, further comprises monitoring the site for cryptographic keys.

3. The method of claim 1, wherein
monitoring the site for cryptographic keys comprises accessing the site via a first network using a first browser configured to access the site; and
the alert is sent to a Cybersecurity Response Team (CRT) system via a second network using a second browser, the first browser and the second browser are different, and the first network and the second network is different.

4. The method of claim 3, wherein
the first network is Dark Web; and
the second network is World Wide Web.

5. The method of claim 1, wherein
the first cryptographic key comprises a private key;
the second cryptographic key comprises a public key corresponding to the private key; and
the private key and the public key are generated as a public/private key pair.

6. The method of claim 1, wherein the first cryptographic key is used to encrypt a third cryptographic key.

7. The method of claim 1, wherein
the first cryptographic key and the second cryptographic key are symmetric keys; and
one of:
the first cryptographic key and the second cryptographic key are same; or
the second cryptographic key is derived from the first cryptographic key using a key derivation function.

8. The method of claim 1, wherein the at least one cryptographic attribute comprises a length of a bit string, the information comprising the string.

9. The method of claim 8, wherein determining, based on the at least one cryptographic attribute, that the information on the site is the first cryptographic key comprises:
determining that the string has a length equal to a predetermined length or within a predetermined range of lengths.

10. The method of claim 1, wherein the at least one cryptographic attribute comprises a predetermined string.

11. The method of claim 1, further comprising identifying an entity that owns at least one of the first cryptographic key or the second cryptographic key.

12. The method of claim 11, wherein identifying the entity comprises:
determining the second cryptographic key using the first cryptographic key;
determining a certificate of the second cryptographic key; and
determining the entity from the certificate.

13. The method of claim 11, wherein identifying the entity comprises extracting identifying information of the entity from the site on which the first cryptographic key is posted.

14. The method of claim 13, wherein the extracting the identifying information comprises determining the identifying information from a key block, wherein the first cryptographic key and the second cryptographic key are symmetric keys.

15. A system, comprising:
at least one processing circuit each comprising at least one processor and at least one memory, wherein the at least one processor is configured to:
determine, based on at least one cryptographic attribute, that information on a site is a first cryptographic key; and
send an alert that at least one of the first cryptographic key or a second cryptographic key corresponding to the first cryptographic key is compromised.

16. The system of claim 15, wherein
the first cryptographic key comprises a private key;
the second cryptographic key comprises a public key corresponding to the private key; and
the private key and the public key are generated as a public/private key pair.

17. The system of claim 15, wherein the at least one cryptographic attribute comprises a length of a string, the information comprising the string.

18. The system of claim 15, wherein the at least one cryptographic attribute comprises a predetermined string.

19. The system of claim 15, wherein
the first cryptographic key and the second cryptographic key are symmetric keys; and
one of:
the first cryptographic key and the second cryptographic key are same; or
the second cryptographic key is derived from the first cryptographic key using a key derivation function.

20. One or more non-transitory computer-readable media comprising computer-readable instructions, such that, when executed, causes at least one processor to:
determine, based on at least one cryptographic attribute, that information on a site is a first cryptographic key; and
send an alert that at least one of the first cryptographic key or a second cryptographic key corresponding to the first cryptographic key is compromised.
